(19) United States
(12) Patent Application Publication
(10) Pub. No.: US 2022/0060348 A1
(43) Pub. Date: Feb. 24, 2022

(54) METHOD FOR DYNAMICALLY BUILDING ENVIRONMENT CONDITIONING RULE LIST IN SMART HOME, AND DEVICE

(71) Applicant: BEIJING MORAN COGNITIVE TECHNOLOGY CO., LTD., Beijing (CN)

(72) Inventors: Shuaixiang Dai, Beijing (CN); Bo Fan, Beijing (CN); Guohua Li, Beijing (CN); Weimeng Zhang, Beijing (CN); Zhiwei Yuan, Beijing (CN)

(21) Appl. No.: 17/418,772

(22) PCT Filed: Dec. 25, 2019
(86) PCT No.: PCT/CN2019/128244

§ 371 Date: Jun. 25, 2021

(30) Foreign Application Priority Data
Dec. 26, 2018 (CN) 201811601872.8

(51) Int. Cl. H04L 12/28; H04W 76/10

(52) U.S. Cl. CPC H04L 12/2809; H04W 76/10

(57) ABSTRACT

Disclosed in embodiments of the present disclosure are a method for dynamically building an environment conditioning rule list in smart home, and a device. The method comprises: upon successful access of a smart home network by a first smart home apparatus, acquiring an environment conditioning function of the first smart home apparatus, a smart home apparatus set having access to the smart home network, and environment conditioning functions of one or more smart home apparatuses in the set, and determining, from the one or more smart home apparatuses, one or more second smart home apparatuses having the same environment conditioning function as the first smart home apparatus, to dynamically build an environment conditioning rule list of the smart home network. The method achieves dynamic building of apparatus rule list of the smart home network when a smart home apparatus accesses the network for the first time, and enables highly efficient coordination between multiple smart home apparatuses having the same environment conditioning function.

### CROSS-REFERENCE TO RELATED APPLICATION

This application claims priority to Chinese Patent Application No. 201811601872.8 filed in the China Patent Office on Dec. 26, 2018, entitled “method for dynamically building environment conditioning rule list in smart home and device”, the disclosure of which is hereby incorporated by reference in its entirety.

### TECHNICAL FIELD

The present disclosure relates to the field of smart homes, and more particularly, to a method for dynamically building an environment conditioning rule list in smart home, and a device.

### BACKGROUND

With the advent of the era of Internet intelligence, the intelligent control technologies and information technologies have developed rapidly, with the popularity of various mobile smart terminals, intelligence has gradually been applied to the traditional household apparatuses, the concept of smart home has gradually entered the life of users, and the users can control the smart apparatuses at home through their mobile terminals, which makes the life of the users more convenient.

Multiple smart home apparatuses or various smart home apparatuses have similar environment monitoring and conditioning functions, and when the environment changes, the smart home apparatuses need to change their state to adjust, for example, when the indoor temperature is detected to be too high, the associated apparatuses are air conditioners, electric fans, ventilators, heaters, etc., that is, the indoor temperature can be reduced by turning on the air conditioner, decreasing the heating temperature of the air conditioner, setting the air conditioner to a cooling mode, turning on the electric fan, adjusting the wind level of the electric fan to fast, turning on the ventilator, adjusting the heater to a lower gear, turning off the heater and other methods, at this time, for which apparatuses the states should be adjusted and how to efficiently coordinate the work of multiple apparatuses are problems to be resolved urgently.

### SUMMARY

The embodiments of the present disclosure provide a method for dynamically building an environment conditioning rule list in a smart home and a device.

The embodiments of the present disclosure provide a method for dynamically building an environment conditioning rule list in smart home, including:

sending a smart home network access request to a cloud server, by a first smart home apparatus when accessing the smart home network for the first time;

returning an access response to the first smart home apparatus by the cloud server, and establishing a connection with the cloud serve by the first smart home apparatus to successfully access the smart home network;

acquiring, by the cloud server, an environment conditioning function of the first smart home apparatus;

acquiring, by the cloud server, a smart home apparatus set having accessed to the smart home network; and

acquiring, the environment conditioning functions of one or more smart home apparatuses included in the smart home apparatus set, and determining, from the one or more smart home apparatuses, one or more second smart home apparatuses having the same environment conditioning function as the first smart home apparatus, by the cloud server; and dynamically building an environment conditioning rule list of the smart home network, by the cloud server, based on an environment conditioning alternative rule list stored therein, the environment conditioning function, the first smart home apparatus and the one or more second smart home apparatuses.

The embodiments of the present disclosure provide a device for dynamically building an environment conditioning rule list in smart home, the device including:

an access request receiving unit, configured to receive a smart home network access request sent by a first smart home apparatus when the first smart home apparatus accesses the smart home network for the first time;

an access response sending unit, configured to return an access response to the first smart home apparatus, and establish a connection with the first smart home apparatus, to enable the first smart home apparatus to access the smart home network successfully;

a first acquiring unit, configured to acquire an environment conditioning function of the first smart home apparatus;

a second acquiring unit, configured to acquire a smart home apparatus set having accessed to the smart home network;

a third acquiring unit, configured to acquire the environment conditioning functions of one or more smart home apparatuses included in the smart home apparatus set;

a determining unit, configured to determine, from the one or more smart home apparatuses, one or more second smart home apparatuses having the same environment conditioning function as the first smart home apparatus;

a rule building unit, configured to dynamically build an environment conditioning rule list of the smart home network based on an environment conditioning alternative rule list, the environment conditioning function, the first smart home apparatus and the one or more second smart home apparatuses; and

a storage unit, configured to store the environment conditioning alternative rule list.

The embodiments of the present disclosure provide a system for dynamically building an environment conditioning rule list in smart home, including the device described above and one or more smart home networks which include one or more smart home apparatuses.

The embodiments of the present disclosure provide a computer apparatus including a processor and memory for storing processor executable computer instructions, and when the processor executes the computer instructions, the method described above is executed.

The embodiments of the present disclosure provide a computer-readable storage medium having stored therein computer instructions for executing the method described above.

Through the method, device, and system of the present disclosure, when a smart home apparatus accesses the smart home network for the first time, an environment conditioning rule list of the smart home network can be dynamically built, such that when the user issues an instruction such as increasing the temperature, appropriate smart home apparatuses can be selected for control according to the environment conditioning rule list of the smart home network, that is, a highly efficient coordination between multiple smart home apparatuses having the same environment conditioning function is made, which meets the user requirement while avoiding resource waste, thereby improving the user experience.

### BRIEF DESCRIPTION OF THE DRAWINGS

FIG. 1 is a smart home system to which a method and a device for dynamically building an environment conditioning rule list in a smart home provided by embodiments of the present disclosure are applicable.

FIG. 2 is a method for dynamically building an environment conditioning rile list provided by embodiments of the present disclosure.

FIG. 3 is a device for dynamically building an environment conditioning rule list provided by embodiments of the present disclosure.

### DETAILED DESCRIPTION

In order to make the objectives, technical solutions, and advantages of the present disclosure clearer, the present disclosure will be further described in detail below with reference to the accompanying drawings. Obviously, the described embodiments are only a part of the embodiments of the present disclosure, rather than all embodiments. Based on the embodiments in the present disclosure, all other embodiments obtained by a person of ordinary skill in the art without creative work shall fall within the scope of the present disclosure.

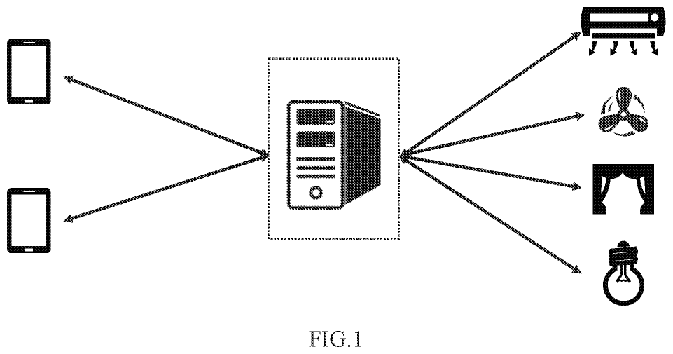

A method for dynamically building an environment conditioning rule list in a smart home according to the present disclosure is applied to the system shown in FIG. 1, and the system includes a smart terminal, a cloud server, and one or more smart home apparatuses.

Herein, there may be one or more smart terminals, which specifically can be terminals with a certain level of intelligence, such as mobile phones, PDAs, tablet computers, portable computers, and wearable apparatuses.

The smart terminal receives the user instructions and sends them to the cloud server. The smart terminal and the cloud server can be connected using a long-distance communication protocol such as a cellular network or a short-distance communication protocol such as Wi-Fi, Bluetooth, NFC, etc., which is not limited in the present disclosure. In an embodiment, the smart terminal can process the acquired user instruction and then send it to the cloud server. For example, when the user instruction is voice, the smart terminal may perform voice recognition on the user instruction and then sending the same out to reduce the amount of data transmitted; in another embodiment, the smart terminal may not perform the above processing, but directly send the acquired voice instruction to the cloud server, and the voice recognition is performed by the cloud server, which can reduce the processing load of the smart terminal on the one hand, and on the other hand, the accuracy is higher when the text conversion is performed by the cloud server. In another embodiment, if the user instruction can be recognized according to the locally stored voice instruction database, the smart terminal can perform the text conversion for a part of the user instructions and then send them to the cloud server, and if the user instruction cannot be recognized according to the locally stored voice instruction database, the text conversion is not performed for the user instruction, and the acquired voice instruction is sent directly to the cloud server.

One or more smart terminals can have different control permissions, and when the instructions issued by different smart terminals for the same smart apparatus are opposite, the system executes the instructions issued by the smart terminal with high control permissions; at this time, the system can also return prompt information to the smart terminal with low control permissions to prompt the user why the instruction has not been executed.

After receiving the user instruction from the smart terminal, the cloud server parses and processes the user instruction, determines the target smart apparatus corresponding to the user instruction and the control action corresponding to the user instruction, and sends the control instruction carrying the control action to the target smart apparatus.

The cloud server can also be a smart home gateway or a smart home router, and the above three terms have the same function in the disclosure and can be replaced with each other. The cloud server can be connected with smart apparatuses through a long-distance communication protocol such as a cellular network, and can also be connected with smart apparatuses through a short-distance communication protocol such as Wi-Fi, Bluetooth, NFC, etc.

The smart apparatus can specifically be smart doors and windows, smart humidifiers, smart air conditioners, smart heater, smart ventilators, smart fan heaters, smart air purifiers, smart curtains, smart light bulbs, and the like.

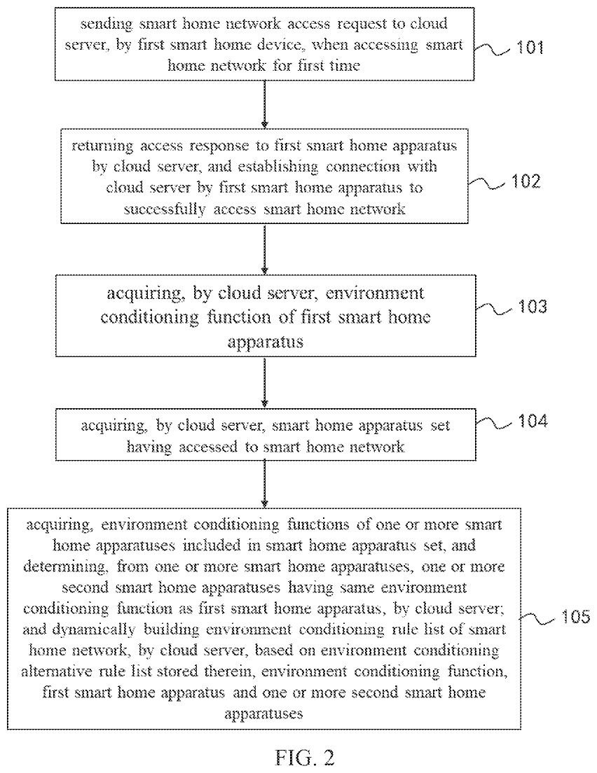

Next, the method for dynamically building an environment conditioning rule list in a smart home according to the present disclosure will be described, with reference to FIG. 2, the method includes the following steps.

In step 101, a smart home network access request is sent to a cloud server, by a first smart home device, when accessing a smart home network for the first time.

In step 102, an access response is returned to the first smart home apparatus by the cloud server, a connection with the cloud server is established by the first smart home apparatus to successfully access the smart home network.

In step 103, an environment conditioning function of the first smart home apparatus is acquired by the cloud server.

In step 104, a smart home apparatus set having accessed to the smart home network is acquired by the cloud server.

In step 105, by the cloud server, the environment conditioning functions of one or more smart home apparatuses included in the smart home apparatus set are acquired, and one or more second smart home apparatuses having the same environment conditioning function as the first smart home apparatus are determined from the one or more smart home apparatuses; and an environment conditioning rule list of the smart home network is dynamically built, based on an environment conditioning alternative rule list stored therein, the environment conditioning function, the first smart home apparatus and the one or more second smart home apparatuses.

Preferably, after step 104, step 104a is performed to determine whether the smart home apparatus set is empty, if not, step 105 is performed, and if yes, step 106 is performed.

In step 106, an environment conditioning rule list of the smart home network is dynamically built by the cloud server based on an environment conditioning alternative rule list stored therein, the environment conditioning function, and the first smart home apparatus.

Next, the above method will be described in detail in combination with specific scenarios.

In scenario 1, the heater has accessed to the smart home network, and the first smart home apparatus is an air conditioner.

Steps 101-102 are the processes of the first smart home apparatus, that is, the air conditioner, accessing the smart home network for the first time, and the first smart home apparatus, that is, the air conditioner sends an access request to the cloud server, and if the cloud server allows the first smart home apparatus, that is, the air conditioner, to access the smart home network, it returns an access response to the first smart home apparatus, that is, the air conditioner, such that a connection is established between the two and the access process is completed. The cloud server can authenticate the first smart home apparatus, that is, the air conditioner, and if the authentication is passed, the first smart home apparatus, that is, the air conditioner is allowed to access the smart home network. The specific authentication process can use any authentication method in the prior art, which is not limited in the present disclosure.

In step 103, the cloud server acquires the environment conditioning function of the air conditioner. The environment conditioning function may be the functions of conditioning environment-related parameters such as increasing temperature, decreasing temperature, increasing humidity, decreasing humidity, increasing brightness, decreasing brightness, and the like. Preferably, a smart home apparatus function table is stored in the cloud server, and referring to Table 1, the environment conditioning functions of the air conditioner obtained by searching the table are increasing temperature and decreasing temperature, hereinafter, only the case in which the environment conditioning function of the air conditioner is increasing temperature is taken as an example to make a description.

It should be noted that Table 1 is only a smart home apparatus function table for illustrating the method of the present disclosure, and the functions of the smart home apparatus are not limited to the functions listed in the smart home apparatus function table shown in Table 1, for example, the air conditioner also has a humidification function, and thus its environment conditioning function and working state can also be increasing humidity and humidification. In addition, the smart home apparatus is not limited to the smart home apparatuses listed in the smart home apparatus function table shown in Table 1, and may also be other smart home apparatuses, such as humidifiers, air purifiers, and the like. Preferably, the smart home apparatus function table stored in the cloud server should be able to fully cover any type of smart home apparatuses that consumers can purchase on the market. The cloud server can regularly update the smart home apparatus function table, and in another embodiment, the manufacturer of the smart home apparatus notifies the cloud server to update the smart home apparatus function table in real time after the new smart home apparatus is on the market.

TABLE 1
Smart home apparatus Function Table

| | | | Environment Conditioning Alternative | |
|---|---|---|---|---|
| | | | Rules | |
| | Environment | Rule | Control Priority | |
| | Conditioning | Application | (From High to | |
| NO. | Function | Condition | Low | Control Operation |
| 1 | Increasing | Heating | Heater | Turn on/Adjust to a |
| | Temperature | Season | | Higher Gear |
| | | | Conditioner | Heat/Adjust |
| | | | | to a Higher |
| | | | | Temperature |
| | | | Fan Heater | Turn on/Adjust to a |
| | | | | Higher Gear |
| 2 | Increasing | Non-Heating | Conditioner | Heat/Adjust to |
| | Temperature | Season | | a Higher |
| | | | | Temperature |
| | | | Fan Heater | Turn on/Adjust to a |
| | | | | Higher Gear |
| 3 | Decreasing | Heating | Heater | Turn off/Adjust to a |
| | Temperature | Season | | Lower Gear |
| | | | Conditioner | Turn off/Adjust to a |
| | | | | Lower Temperature |
| 4 | Decreasing | Non-heating | Conditioner | Turn on/Adjust to a |
| | Temperature | Season | | Lower Temperature |
| | | | Fan | Turn on/Adjust to a |
| | | | | Higher Gear |

In step 104, the cloud server acquires the smart home apparatus set having accessed to the smart home network. In the scenario, before the air conditioner accesses the smart home network, the heater has accessed to the smart home network-, and then in step 104, the smart home apparatus set includes the heater.

In step 105, the cloud server acquires the environment conditioning functions of one or more smart home apparatuses included in the smart home apparatus set, and determines, from the one or more smart home apparatuses, one or more second smart home apparatuses having the same environment conditioning function as the first smart home apparatus; and the cloud server dynamically builds the environment conditioning rule list of the smart home network-, based on an environment conditioning alternative rule list stored therein, the environment conditioning function, the first smart home apparatus and the one or more second smart home apparatuses. Herein, the environment conditioning functions of one or more smart home apparatuses included in the smart home apparatus set may be acquired by a method similar to acquiring the environment conditioning function of the first smart home apparatus, and details are not described herein again. In the scenario, taking the environment conditioning function of increasing temperature as an example, the smart home apparatus set includes a heater, and the environment conditioning function of the heater obtained by the cloud server is increasing temperature and decreasing temperature, since the heater and the air conditioner have the same environment conditioning function, i.e., increasing temperature, the heater in the smart home apparatus set is a second smart home apparatus. At this time, the cloud sever dynamically builds the environment conditioning rule list of the smart home network, based on an environment conditioning alternative rule list stored therein, increasing temperature, the air conditioner and the heater.

Preferably, an environment conditioning alternative rule corresponding to the environment conditioning function is stored in the environment conditioning alternative rule list, wherein there are one or more environment conditioning functions, and there may be one or more the environment conditioning alternative rules corresponding to the environment conditioning function; and preferably, each of the environment conditioning alternative rules also has a corresponding rule application condition. In the environment conditioning alternative rule, control priorities and corresponding control operations of one or more smart home apparatuses with the environment conditioning function are defined. Table 2 shows an example of the environment conditioning alternative rule list, wherein there are two environment conditioning alternative rules corresponding to increasing temperature, whose serial numbers are 1 and 2, respectively, and the environment conditioning alternative rules with the serial number 1 are applied to the heating season, and include the control priorities and the corresponding control operations of three smart home apparatuses with the function of increasing temperature, namely the heater, the air conditioner, and the fan heater, that is, when it is in the heating season, if the indoor temperature needs to be raised, preferably, the heater is turned on or the heater is adjusted to a higher gear, if the above operations on the heater cannot meet the user requirements (such as the heater failure, the poor heating performance of the heater, and the difference between the current indoor temperature and the temperature required by the user being too large), the air conditioner is controlled to turn on and a heating mode is set or the heating temperature of the air conditioner is adjusted to a higher temperature, and if the above operations on the heater or the air conditioner still cannot meet the user requirements, the fan heater is turned on or the fan heater is adjusted to a higher gear. The environment conditioning alternative rules with the serial number 2 are applied to the non-heating season, since the heater does not have the function of temperature regulation in the non-heating season, only the control priorities of the air conditioner and the fan heater are given in the environment conditioning alternative rules with the serial number 2.

TABLE 2
Environment Conditioning Alternative Rule List

| | | | Environment Conditioning | |
|---|---|---|---|---|
| | | Rule | alternative Rules | |
| | Environment | Application | Control Priority | |
| | Conditioning | Air | (From High to | |
| NO. | Function | Condition | Low) | Control Operation |
| 1 | Increasing | Heating | Heater | Turn on/Adjust to a |
| | Temperature | Season | | Higher Gear |
| | | | Air Conditioner | Heat/Adjust |
| | | | | to a Higher |
| | | | | Temperature |
| | | | Fan Heater | Turn on/Adjust to a |
| | | | | Higher Gear |
| 2 | Increasing | Non-Heating | Air Conditioner | Heat/Adjust |
| | Temperature | Season | | to a Higher |
| | | | | Temperature |
| | | | Fan Heater | Turn on/Adjust to a |
| | | | | Higher Gear |
| 3 | Decreasing | Heating | Heater | Turn off/Adjust to a |
| | Temperature | Season | | Lower Gear |
| | | | Air Conditioner | Turn off/Adjust to a |
| | | | | Lower Temperature |
| 4 | Decreasing | Non-Heating | Air Conditioner | Turn on/Adjust to a |
| | Temperature | Season | | Lower Temperature |
| | | | Fan | Turn on/Adjust to a |
| | | | | Higher Gear |

The environment conditioning alternative rule list stored in the cloud server may be set in advance in the cloud server, or may be obtained by collecting user habits of other smart home networks and then analyzing and summarizing the big data. It should be noted that Table 2 is only an environment conditioning alternative rule list for illustrating the method of the present disclosure, and the environment conditioning alternative rules are not limited to the four environment conditioning alternative rules shown in Table 2. On the one hand, the corresponding environment conditioning alternative rules can be set for other environment conditioning functions, and on the other hand, when setting the environment conditioning alternative rules for increasing or decreasing temperature, the following factors can also be considered: user characteristics such as age, gender and the like in a step of requesting conditioning and the difference between the current environmental parameter value and the target value. By considering a variety of factors to set the environment conditioning rule list, it is possible to better meet the user requirement and improve the user experience.

In step 105, the dynamically building an environment conditioning rule list of the smart home network is, specifically, that the cloud server searches the environment conditioning alternative rule list to obtain an environment conditioning alternative rule sub-list corresponding to the environment conditioning function of the first smart home apparatus, and writes the control priorities and the corresponding control operations related to the first smart home apparatus and the second smart home apparatus in the environment conditioning alternative rules involving the first smart home apparatus and the second smart home apparatus in the environment conditioning alternative rule sub-list into the environment conditioning rule list of the smart home network. Preferably, the environmental impact parameters and the rule application conditions corresponding to the environment conditioning alternative rules involving the first smart home apparatus and the second smart home apparatus in the environment conditioning alternative rule sub-list are also written into the environment conditioning rule list of the smart home network.

In the present scenario, the dynamically built environment conditioning rule list of the smart home network is shown in Table 3, and the environment conditioning rule list of the smart home network has the same data structure as the environment conditioning alternative rule list. Since the smart home apparatuses having accessed to the smart home network do not include fan heaters, fans, windows/doors, the generated environment conditioning rule list also includes the above-mentioned types of smart home apparatuses.

TABLE 3
Environment Conditioning Rule List of Smart Home Network

| | | | Environment Conditioning | |
|---|---|---|---|---|
| | | | alternative Rules | |
| | Environment | Rule | Control Priority | |
| | Conditioning | Application | (From High to | |
| NO. | Function | Condition | Low) | Control Operation |
| 1 | Increasing | Heating | Heater | Turn on/Adjust to a |
| | Temperature | Season | | Higher Gear |
| | | | Air Conditioner | Heat/Adjust |
| | | | | to a Higher |
| | | | | Temperature |
| 2 | Increasing | Non-Heating | Air Conditioner | Heat/Adjust |
| | Temperature | Season | | to a Higher |
| | | | | Temperature |
| 3 | Decreasing | Heating | Heater | Turn off/Adjust to a |
| | Temperature | Season | | Lower Gear |
| | | | Air Conditioner | Turn off/Adjust to a |
| | | | | Lower Temperature |
| 4 | Decreasing | Non-Heating | Air Conditioner | Turn on/Adjust to a |
| | Temperature | Season | | Lower Temperature |

Through the method of the present disclosure, when the smart home apparatus accesses the smart home network for the first time, the environment conditioning rule list of the smart home network can be dynamically built, such that when the user issues an instruction such as increasing temperature, appropriate smart home apparatuses can be selected for control according to the environment conditioning rule list of the smart home network, that is, highly efficient coordination is performed between multiple smart home apparatuses having the same environment conditioning function, which meets user requirements while avoiding resource waste, thereby improving the user experience.

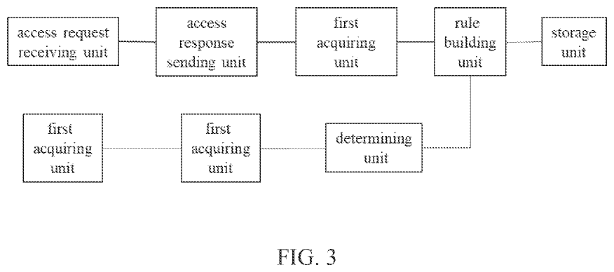

The embodiments of the present disclosure provide a device for dynamically building an environment conditioning rule list in smart home, and as shown in FIG. 3, the device includes:

an access request receiving unit, configured to receive a smart home network access request sent by a first smart home apparatus when the first smart home apparatus accesses the smart home network for the first time;

an access response sending unit, configured to return an access response to the first smart home apparatus, and establish a connection with the first smart home apparatus, such that the first smart home apparatus accesses the smart home network successfully;

a first acquiring unit, configured to acquire an environment conditioning function of the first smart home apparatus;

a second acquiring unit, configured to acquire a smart home apparatus set having accessed to the smart home network;

a third acquiring unit, configured to acquire the environment conditioning functions of one or more smart home apparatuses included in the smart home apparatus set;

a determining unit, configured to determine, from the one or more smart home apparatuses, one or more second smart home apparatuses having the same environment conditioning function as the first smart home apparatus;

a rule building unit, configured to dynamically build an environment conditioning rule list of the smart home network based on an environment conditioning alternative rule list, the environment conditioning function, the first smart home apparatus and the one or more second smart home apparatuses; and

a storage unit, configured to store the environment conditioning alternative rule list.

Preferably, the device further includes: an authenticating unit configured to authenticate the first smart home apparatus; and the access response sending module configured to return an access response to the first smart home apparatus when authentication is passed.

Preferably, the determining unit is further configured to determine whether the smart home apparatus set is empty, if not, determine, from the one or more smart home apparatuses, one or more second smart home apparatuses.

Preferably, the storage unit is further configured to store a smart home apparatus function table; and the first acquiring unit is configured to acquire the environment conditioning functions of the first smart home apparatus based on the smart home apparatus function table.

Preferably, the device further includes an updating unit configured to regularly update the smart home apparatus function table; or, configured to update the smart home apparatus function table based on real-time notification from a manufacturer of the smart home apparatus.

Preferably, an environment conditioning alternative rule corresponding to the environment conditioning function is stored in the environment conditioning alternative rule list, wherein there are one or more environment conditioning functions, and there are one or more environment conditioning alternative rules corresponding to the environment conditioning functions.

Preferably, each of the environment conditioning alternative rules has a corresponding rule application condition.

Preferably, in the environment conditioning alternative rule, control priorities and corresponding control operations of one or more smart home apparatuses with the environment conditioning function are defined.

Preferably, the rule building unit is configured to: search the environment conditioning alternative rule list to obtain an environment conditioning alternative rule sub-list corresponding to the environment conditioning function of the first smart home apparatus, and write the control priorities and the corresponding control operations related to the first smart home apparatus and the second smart home apparatus in the environment conditioning alternative rules related to the first smart home apparatus and the second smart home apparatus in the environment conditioning alternative rule sub-list into the environment conditioning rule list of the smart home network.

Preferably, the environment conditioning rule list of the smart home network has the same data structure as the environment conditioning alternative rule list.

Preferably, the device is located in a cloud server.

The embodiments of the present disclosure provides a system for dynamically building an environment conditioning rule list in smart home, including the device described above and one or more smart home networks which include one or more smart home apparatuses.

The embodiments of the present disclosure provides a computer apparatus including a processor and memory for storing processor executable computer instructions, and when the processor executes the computer instructions, the above-mentioned methods are implemented.

The embodiments of the present disclosure provide a computer-readable storage medium having stored therein computer instructions for implementing the methods described above.

Any combination of one or more computer-readable media can be used. The computer-readable medium can be a computer-readable signal medium or a computer-readable storage medium. The computer-readable storage medium can be, for example, but not limited to, an electrical, magnetic, optical, electromagnetic, infrared, or semiconductor system, apparatus, or device, or a combination of any of the above. The computer-readable storage medium may include: an electrical connection with one or more wires, a portable computer disk, a hard disk, a random access memory (RAM), read-only memory (ROM), a flash memory, an erasable programmable read-only memory (EPROM), an optical fiber, a portable compact disk read-only memory (CD-ROM), an optical storage device, a magnetic storage device, or any suitable combination of the above. In this document, the computer-readable storage medium can be any tangible medium that contains or stores a program, and the program can be used by or in combination with an instruction execution system, apparatus, or device.

The computer program code for performing the operations of the present disclosure can be written in one or more programming languages or a combination thereof

The above description is merely an example to facilitate the understanding of the present disclosure, and is not used to limit the scope of the present disclosure. In the specific implementation, those skilled in the art can change, increase, or reduce the components of the device according to the actual situation, and can change, increase, reduce the steps of the method or change the order of the steps of the method according to the actual situation without affecting the functions realized by the method.

While the embodiments of the present disclosure have been shown and described, those skilled in the art should understand that various variations, alterations, substitutions, and modifications can be made to these embodiments without departing from the principles and purposes of the present disclosure, and the scope of the present disclosure is defined by the claims and their equivalent replacements, and improvements made without creative work should be embraced within the protection scope of the present disclosure.

1. A method for dynamically building an environment conditioning rule list in smart home, comprising:
sending a smart home network access request to a cloud server, by a first smart home device, when accessing a smart home network for the first time;
returning an access response to the first smart home apparatus by the cloud server, and establishing a connection with the cloud server by the first smart home apparatus to successfully access the smart home network;
acquiring, by the cloud server, an environment conditioning function of the first smart home apparatus;
acquiring, by the cloud server, a smart home apparatus set having accessed to the smart home network; and
acquiring, the environment conditioning functions of one or more smart home apparatuses included in the smart home apparatus set, and determining, from the one or more smart home apparatuses, one or more second smart home apparatuses having the same environment conditioning function as the first smart home apparatus, by the cloud server, and dynamically building an environment conditioning rule list of the smart home network, by the cloud server, based on an environment conditioning alternative rule list stored therein, the environment conditioning function, the first smart home apparatus and the one or more second smart home apparatuses.

2. The method according to claim 1, wherein the first smart home apparatus is authenticated and an access response is returned to the first smart home apparatus when authentication is passed by the cloud server.

3. The method according to claim 1, wherein the method further comprises:
determining whether the smart home apparatus set is empty; and
when the smart home apparatus set is not empty, acquiring, by the cloud server, the environment conditioning functions of one or more smart home apparatuses included in the smart home apparatus set, and determining, from the one or more smart home apparatuses, one or more second smart home apparatuses.

4. The method according to claim 1, wherein a smart home apparatus function table is stored in the cloud server, and
the acquiring, by the cloud server, an environment conditioning function of the first smart home apparatus specifically includes: acquiring, by the cloud server, the environment conditioning function of the first smart home apparatus based on the smart home apparatus function table.

5. The method according to claim 4, wherein the method further comprises at least one of:
updating regularly, by the cloud server, the smart home apparatus function table; and
notifying the cloud server in real time, by a manufacturer of the smart home apparatus, to update the smart home apparatus function table.

6. The method according to claim 1, wherein storing an environment conditioning alternative rule corresponding to the environment conditioning function in the environment conditioning alternative rule list, wherein there are one or more environment conditioning functions, and there are one or more environment conditioning alternative rules corresponding to the environment conditioning functions.

7. The method according to claim 6, wherein each of the environment conditioning alternative rules has a corresponding rule application condition.

8. The method according to claim 6, wherein defining, in the environment conditioning alternative rule, control priorities and corresponding control operations of one or more smart home apparatuses with the environment conditioning function.

9. The method according to claim 8, wherein the dynamically building an environment conditioning rule list of the smart home network comprises: searching the environment conditioning alternative rule list, by the cloud server, to obtain an environment conditioning alternative rule sub-list corresponding to the environment conditioning function of the first smart home apparatus, and writing the control priorities and the corresponding control operations related to the first smart home apparatus and the second smart home apparatus in the environment conditioning alternative rules related to the first smart home apparatus and the second smart home apparatus in the environment conditioning alternative rule sub-list into the environment conditioning rule list of the smart home network.

10. The method according to claim 9, wherein the environment conditioning rule list of the smart home network has the same data structure as the environment conditioning alternative rule list.

11. A device for dynamically building an environment conditioning rule list in smart home, comprising:
an access request receiving circuit, configured to receive a smart home network access request sent by a first smart home apparatus when the first smart home apparatus accesses the smart home network for the first time;
an access response sending circuit, configured to return an access response to the first smart home apparatus, and establish a connection with the first smart home apparatus, to enable the first smart home apparatus to access the smart home network successfully;
a first acquiring circuit configured to acquire an environment conditioning function of the first smart home apparatus;
a second acquiring circuit, configured to acquire a smart home apparatus set having accessed to the smart home network;
a third acquiring circuit, configured to acquire the environment conditioning functions of one or more smart home apparatuses included in the smart home apparatus set;
a determining circuit, configured to determine, from the one or more smart home apparatuses, one or more second smart home apparatuses having the same environment conditioning function as the first smart home apparatus;
a rule building circuit, configured to dynamically build an environment conditioning mule list of the smart home network based on an environment conditioning alternative mule list, the environment conditioning functions, the first smart home apparatus and the one or more second smart home apparatuses; and
a storage circuit, configured to store the environment conditioning alternative rule list.

12. The device according to claim 11, wherein the device further comprises: an authenticating circuit configured to authenticate the first smart home apparatus; and
the access response sending circuit, configured to return an access response to the first smart home apparatus when authentication is passed.

13. The apparatus according to claim 11, wherein the determining circuit is further configured to determine whether the smart home apparatus set is empty, if not, determine, from the one or more smart home apparatuses, one or more second smart home apparatuses.

14. The device according to claim 11, wherein the storage circuit is further configured to store a smart home apparatus function table; and
the first acquiring circuit is configured to acquire the environment conditioning functions of the first smart home apparatus based on the smart home apparatus function table.

15. The device according to claim 14, wherein the device further comprises an updating circuit configured to perform at least one of:
updating regularly the smart home apparatus function table, and
updating the smart home apparatus function table based on real-time notification from a manufacturer of the smart home apparatus.

16. The device according to claim 11, wherein an environment conditioning alternative rule corresponding to the environment conditioning function is stored in the environment conditioning alternative rule list, wherein there are one or more environment conditioning functions, and there are one or more environment conditioning alternative rules corresponding to the environment conditioning functions.

17. The device according to claim 11, wherein the rule building circuit is configured to: search the environment conditioning alternative rule list to obtain an environment conditioning alternative rule sub-list corresponding to the environment conditioning function of the first smart home apparatus, and write the control priorities and the corresponding control operations related to the first smart home apparatus and the second smart home apparatus in the environment conditioning alternative rules related to the first smart home apparatus and the second smart home apparatus in the environment conditioning alternative rule sub-list into the environment conditioning rule list of the smart home network.

18. A system for dynamically building an environment conditioning rule list in smart home, comprising the device according to claim 11 and one or more smart home apparatuses.

19. A computer apparatus, wherein the computer apparatus comprises a processor and memory for storing processor executable computer instructions, and when the processor executes the computer instructions, the method according to claim 1 is implemented.

20. A computer-readable storage medium having stored therein computer instructions for implementing the method according to the claim 1.
